(19) United States
(12) Patent Application Publication
(10) Pub. No.: US 2015/0261369 A1
(43) Pub. Date: Sep. 17, 2015

(54) TOUCH PANEL HAVING UNEVENLY DISTRIBUTED ELECTRIC FIELD LINES AND CONTROLLING METHOD THEREOF

(71) Applicant: Henghao Technology Co., Ltd., Hsinchu County (TW)

(72) Inventor: Min-Shan Kuo, Hsinchu County (TW)

(21) Appl. No.: 14/530,726

(22) Filed: Nov. 1, 2014

(30) Foreign Application Priority Data
Mar. 11, 2014 (TW) 103108522

(51) Int. Cl. G06F 3/041

(52) U.S. Cl. CPC G06F 3/0412

(57) ABSTRACT

A touch panel includes a screen, a substrate and a transmitting/receiving unit configured between the screen and the substrate, and having a first surface near the screen and a second surface near the substrate, wherein the size of the first surface is larger than the size of the second surface.

### CROSS-REFERENCES TO RELATED APPLICATIONS

This application claims the benefits of Taiwan Patent Application Number 103108522 filed on Mar. 11, 2014, at the Taiwan Intellectual Property Office, the disclosures of which are incorporated herein in their entirety by reference.

### FIELD OF THE INVENTION

The present invention relates to a touch panel and a controlling method thereof, in particular to a touch panel being used for a liquid crystal display (LCD) and having unevenly distributed electric field lines.

### BACKGROUND OF THE INVENTION

LCD panels are commonly and increasingly used, and LCD panels with projective capacitive touch panels are even more prevalent. Currently, a projective capacitive touch panel has a structure such as the glass-film-film (GFF) structure or the one glass solution (OGS) structure. FIG. 1 shows a schematic diagram of a configuration of a projective capacitive touch panel with a conventional OGS structure (including the LCD). The LCD 1 as shown in FIG. 1 includes a touch panel having an OGS structure 11 and an LCD substrate 12, wherein the touch panel 11 includes a cover glass (CG) 111, an optically clear adhesive (OCA) 112, and an Rx/Tx ITO 113, and the LCD substrate 12 is a color display unit.

FIG. 2 shows a schematic diagram of a projective capacitive touch panel configuration with a conventional OGS structure. As shown in FIG. 2, the touch panel 21 having the OGS structure includes a CG 111, a plurality of OCAs 112, a plurality of conventional sensors 211 and an anti-shatter film (ASF) 212, wherein each sensor 211 includes a conventional transmitter (Tx) 2111 and a conventional receiver (Rx) 2112. In FIG. 2, each transmitter 2111 and each receiver 2112 are the same size from top to bottom, and there are evenly distributed plural electric field lines between each transmitter 2111 and each corresponding receiver 2112 both in upward and downward directions such that a touch of a finger changes the distribution of the electric field lines to sense where the touch happens.

Therefore, how to improve the existing technology to cause the plural electric field lines to be unevenly distributed both in upward and downward directions to increase the sensitivity to the touch and to increase a detecting height of the touch is worthy of further research and improvement.

Keeping the drawbacks of the prior art in mind, and through the use of robust and persistent experiments and research, the applicant has finally conceived a touch panel having unevenly distributed electric field lines and a controlling method thereof.

### SUMMARY OF THE INVENTION

It is an objective of the present invention to provide a touch panel having unevenly distributed electric field lines, wherein the touch panel comprises a sensor, the sensor includes a transmitter parallel to a touch function side, and having a wider first surface and a narrower second surface, and a receiver parallel to the touch function side, and having a wider third surface and a narrower fourth surface such that a plurality of electric field lines distributed above a plane formed by an extension of the first surface and the third surface, and closer to the touch function side than the other side are denser than the plurality of electric field lines distributed below the plane, and closer to the other side than the touch function side to increase the sensitivity to the touch and to increase a detecting height of the touch.

In accordance with the first aspect of the present invention, a touch panel comprises a sensor including a transmitter having a first surface and a second surface, and a receiver having a third surface and a fourth surface, wherein when the sensor is operated, a plurality of electric field lines are generated from the transmitter to the receiver, the touch panel has a touch function side and the other side opposite to the touch function side, the first to the fourth surfaces respectively have a first to a fourth widths, the second width is smaller than the first width, the fourth width is smaller than the third width, the first surface and the third surface are closer to the touch function side than the other side, and the second surface and the fourth surface are closer to the other side than the touch function side such that the plurality of electric field lines distributed above a plane formed by an extension of the first surface and the third surface, and closer to the touch function side than the other side are denser than the plurality of electric field lines distributed below the plane and closer to the other side than the touch function side.

In accordance with the second aspect of the present invention, a touch panel comprises a screen having a touch function side and the other side opposite to the touch function side, and a sensor including a transmitter having a first surface and a second surface, and generating a plurality of electric field lines, wherein the first and the second surfaces respectively have a first and a second widths, the second width is smaller than the first width, the first surface is closer to the touch function side than the other side, and the second surface is closer to the other side than the touch function side such that the plurality of electric field lines distributed above a plane formed by an extension of the first surface, and closer to the touch function side than the other side are denser than the plurality of electric field lines distributed below the plane, and closer to the other side than the touch function side.

In accordance with the third aspect of the present invention, a touch panel comprises a screen, a substrate, and a transmitting/receiving unit configured between the screen and the substrate, and having a first surface near the screen and a second surface near the substrate, wherein the first surface has a size larger than that of the second surface.

In accordance with the fourth aspect of the present invention, a touch panel comprises a screen, a substrate and a transmitting/receiving unit configured between the screen and the substrate, having a first surface near the screen and a second surface near the substrate, and configured to cause electric field lines to be generated by the unit, distributed above the plane formed by an extension of the first surface, and closer to the touch function side than the other side to be denser than those distributed below the plane, and closer to the other side than the touch function side.

In accordance with the fifth aspect of the present invention, a controlling method for a touch panel, wherein the touch panel has a touch function side and the other side opposite to the touch function side, comprises: providing a sensor, wherein the sensor includes a transmitter having a first surface and a second surface and a receiver having a third surface and a fourth surface, the first surface and the third surface are closer to the touch function side than the other side, and the second surface and the fourth surface are closer to the other side than the touch function side; generating a plurality of electric field lines from the transmitter to the receiver when the sensor is operated; and causing the second width to be smaller than the first width and the fourth width to be smaller than the third width such that the plurality of electric field lines distributed above a plane formed by an extension of the first surface and the third surface, and closer to the touch function side than the other side are denser than the plurality of electric field lines distributed below the plane and closer to the other side than the touch function side.

In accordance with the sixth aspect of the present invention, a controlling method for a touch panel, wherein the touch panel includes a screen having a touch function side and the other side opposite to the touch function side, comprises: providing a sensor having a transmitter, wherein the transmitter has a first surface and a second surface, the first surface is closer to the touch function side, and the second surface is closer to the other side; causing the transmitter to generate a plurality of electric field lines when the sensor is operated; and causing the second width to be smaller than the first width such that the plurality of electric field lines distributed above the plane formed by an extension of the first surface, and closer to the touch function side than the other side are denser than those distributed below the plane, and closer to the other side than the touch function side.

### BRIEF DESCRIPTION OF THE DRAWINGS

Other objectives, advantages and the efficacy of the present invention will be described in detail below taken from the preferred embodiments with reference to the accompanying drawings, in which:

FIG. 1 is a schematic diagram of a configuration of a projective capacitive touch panel with a conventional OGS structure (including the LCD).

FIG. 2 is a schematic diagram of a projective capacitive touch panel configuration with a conventional OGS structure.

FIG. 3 is a schematic diagram of a projective capacitive touch panel configuration having an OGS structure according to the first preferred embodiment of the present invention.

FIG. 4 is a schematic diagram of a projective capacitive touch panel configuration having an OGS structure according to the second preferred embodiment of the present invention.

FIG. 5 is a schematic diagram of a projective capacitive touch panel configuration having an OGS structure according to the third preferred embodiment of the present invention.

FIG. 6 is a flow chart of a method using an anisotropic etching to manufacture a transmitter/receiver of a conventional sensor as shown in FIG. 2.

FIG. 7 is a flow chart of a method using an isotropic etching to manufacture a transmitter/receiver of a sensor according to the first to the third preferred embodiments of the present invention.

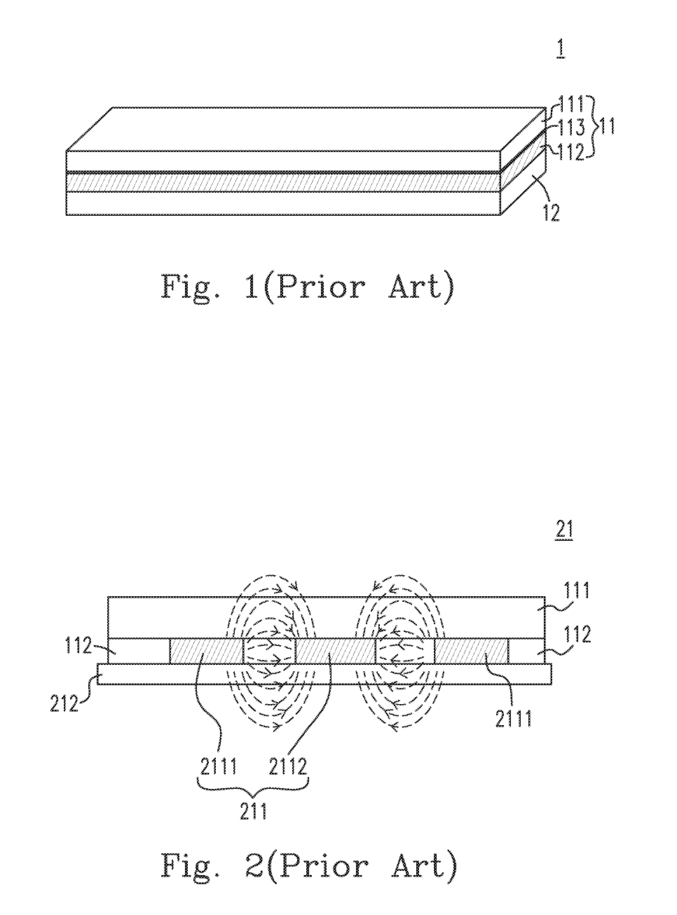

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; they are not intended to be exhaustive or to be limited to the precise form disclosed.

The present invention modifies the uneven distribution of electric field lines via a change of shape of the sensor to cause the sensed electric field lines to deviate toward the touch function side of the touch panel to increase the sensitivity to the touch and to increase the minimum detecting height of the touch. In addition, one advantage of the present invention is that an object as small as a pencil point can be detected. A sensor having a broader top and a narrower bottom or one similar to those in the following preferred embodiments is within the scope of the present invention. The present invention has obvious higher efficiency and better touch function sensitivity and surpasses the existing technologies.

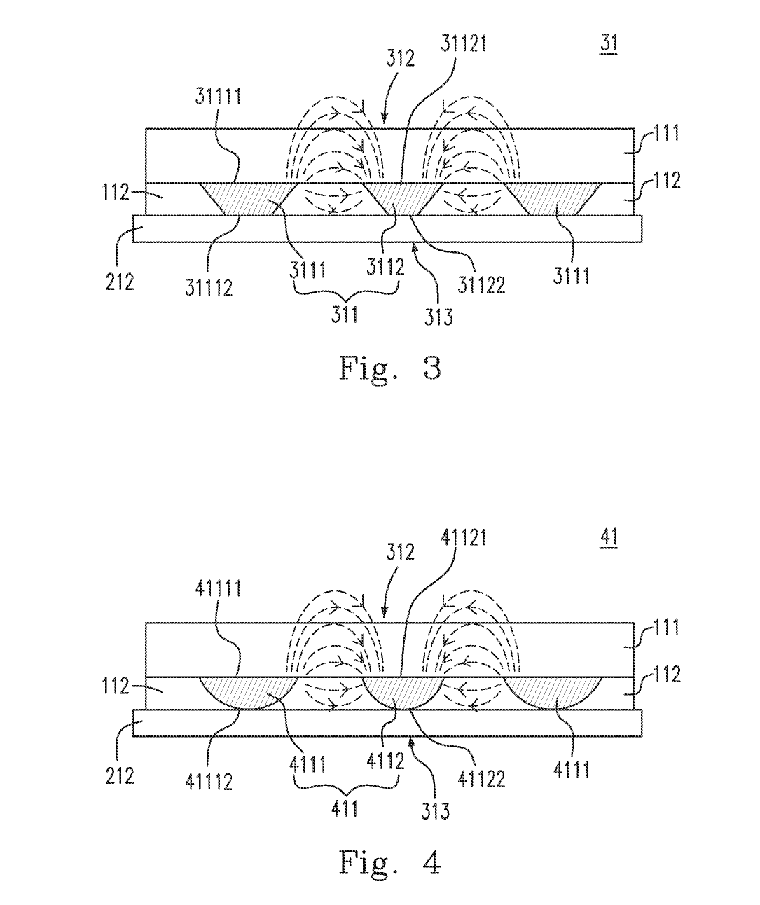

FIG. 3 shows a schematic diagram of a projective capacitive touch panel configuration having an OGS structure according to the first preferred embodiment of the present invention. As shown in FIG. 3, the touch panel 31 having the OGS structure includes a CG (a screen) 111, a plurality of OCAs 112, a plurality of sensors (which are transmitting/receiving units) 311, an ASF 212, a touch function side 312 and the other side 313, wherein each sensor 311 includes a transmitter 3111 and a receiver 3112.

In FIG. 3, each transmitter 3111 has a first surface 31111 closer to the touch function side 312, and a second surface 31112 closer to the other side 313, a first width of the first surface 31111 is larger than a second width of the second surface 31112, each receiver 3112 has a third surface 31121 closer to the touch function side 312, and a fourth surface 31122 closer to the other side 313, and a third width of the third surface 31121 is larger than a fourth width of the fourth surface 31122. Each transmitter 3111 has a first side and a second side respectively at the left-hand side and right-hand side thereof and between the first surface 31111 and the second surface 31112, each receiver 3112 has a third side and a fourth side respectively at the left-hand side and right-hand side thereof and between the third surface 31121 and the fourth surface 31122, a first longitudinal section formed by the first surface 31111, the second surface 31112, the first side and the second side, and a second longitudinal section formed by the third surface 31121, the fourth surface 31122, and the third side and the fourth side are both in the shape of a trapezoid.

Referring to FIG. 3, between each transmitter 3111 and each corresponding receiver 3112, a plurality of electric field lines distributed above a plane formed by an extension of the first surface 31111 and the third surface 31121, and closer to the touch function side 312 than the other side 313 are denser than the plurality of electric field lines distributed below the plane, and closer to the other side 313 than the touch function side 312, such that a touch of a finger or an object (e.g., a stylus pen) changes the distribution of the electric field lines to more sensitively sense where the touch happens.

FIG. 4 shows a schematic diagram of a projective capacitive touch panel configuration having an OGS structure according to the second preferred embodiment of the present invention. As shown in FIG. 4, the touch panel 41 having the OGS structure includes a CG (it is a screen) 111, a plurality of OCAs 112, a plurality of sensors 411, an ASF 212, a touch function side 312 and the other side 313, wherein each sensor 411 includes a transmitter 4111 and a receiver 4112.

In FIG. 4, each transmitter 4111 of the second preferred embodiment of the present invention has a first surface 41111 closer to the touch function side 312, and a second surface 41112 closer to the other side 313, a first width of the first surface 41111 is larger than a second width of the second surface 41112, each receiver 4112 has a third surface 41121 closer to the touch function side 312, and a fourth surface 41122 closer to the other side 313, and a third width of the third surface 41121 is larger than a fourth width of the fourth surface 41122. Each transmitter 4111 has a first side and a second side respectively at the left-hand side and right-hand side thereof and between the first surface 41111 and the second surface 41112, each receiver 4112 has a third side and a fourth side respectively at the left-hand side and right-hand side thereof and between the third surface 41121 and the fourth surface 41122, a first longitudinal section formed by the first surface 41111, the second surface 41112, the first side and the second side, and a second longitudinal section formed by the third surface 41121, the fourth surface 41122, and the third side and the fourth side are both in the shape of a semicircle.

Referring to FIG. 4, between each transmitter 4111 and each corresponding receiver 4112, a plurality of electric field lines distributed above a plane formed by an extension of the first surface 41111 and the third surface 41121, and closer to the touch function side 312 than the other side 313 are denser than the plurality of electric field lines distributed below the plane, and closer to the other side 313 than the touch function side 312, such that a touch of a finger or an object (e.g., a stylus pen) changes the distribution of the electric field lines to more sensitively sense where the touch happens.

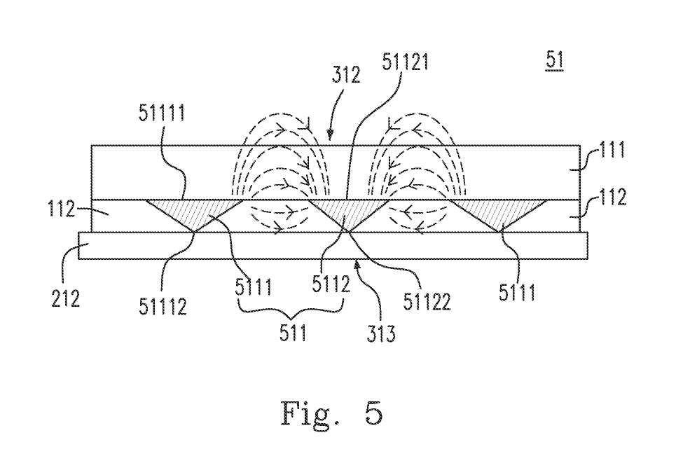

FIG. 5 shows a schematic diagram of a projective capacitive touch panel configuration having an OGS structure according to the third preferred embodiment of the present invention. As shown in FIG. 5, the touch panel 51 having the OGS structure includes a CG (it is a screen) 111, a plurality of OCAs 112, a plurality of sensors 511, an ASF 212, a touch function side 312 and the other side 313, wherein each sensor 511 includes a transmitter 5111 and a receiver 5112.

In FIG. 5, each transmitter 5111 of the third preferred embodiment of the present invention has a first surface 51111 closer to the touch function side 312, and a second surface 51112 closer to the other side 313, a first width of the first surface 51111 is larger than a second width of the second surface 51112, each receiver 5112 has a third surface 51121 closer to the touch function side 312, and a fourth surface 51122 closer to the other side 313, and a third width of the third surface 51121 is larger than a fourth width of the fourth surface 51122. Each transmitter 5111 has a first side and a second side respectively at the left-hand side and right-hand side thereof and between the first surface 51111 and the second surface 51112, each receiver 5112 has a third side and a fourth side respectively at the left-hand side and right-hand side thereof and between the third surface 51121 and the fourth surface 51122, a first longitudinal section formed by the first surface 51111, the second surface 51112, the first side and the second side, and a second longitudinal section formed by the third surface 51121, the fourth surface 51122, and the third side and the fourth side are both in the shape of a triangle.

Referring to FIG. 5, between each transmitter 5111 and each corresponding receiver 5112, a plurality of electric field lines distributed above a plane formed by an extension of the first surface 51111 and the third surface 51121, and closer to the touch function side 312 than the other side 313 are denser than the plurality of electric field lines distributed below the plane, and closer to the other side 313 than the touch function side 312, such that a touch of a finger or an object (e.g., a stylus pen) changes the distribution of the electric field lines to more sensitively sense where the touch happens.

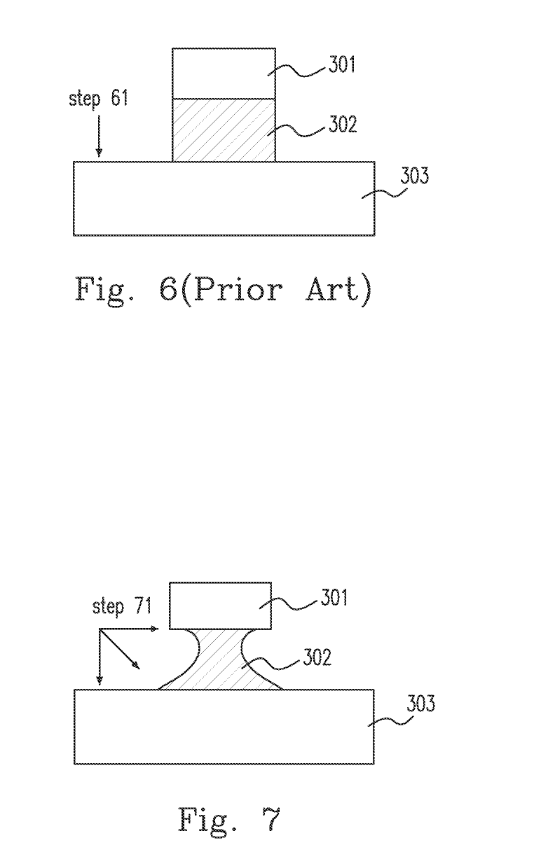

FIG. 6 is a flow chart of a method using an anisotropic etching to manufacture a transmitter/receiver of a conventional sensor as shown in FIG. 2. In FIG. 6, the flow chart includes a photoresist 301, a thin film 302 and a substrate 303, and has a step 61: using an anisotropic etching to manufacture one of a transmitter and a receiver of a sensor.

FIG. 7 is a flow chart of a method using an isotropic etching to manufacture a transmitter/receiver of a sensor according to the first to the third preferred embodiments of the present invention. In FIG. 7, the flow chart includes a photoresist 301, a thin film 302 and a substrate 303, and has a step 71: using an isotropic etching to manufacture one of a transmitter and a receiver of a sensor.

### Embodiments

1. A touch panel, comprising a sensor including:

a transmitter having a first surface and a second surface; and

a receiver having a third surface and a fourth surface,

wherein when the sensor is operated, a plurality of electric field lines are generated from the transmitter to the receiver, the touch panel has a touch function side and the other side opposite to the touch function side, the first to the fourth surfaces respectively have a first to a fourth widths, the second width is smaller than the first width, the fourth width is smaller than the third width, the first surface and the third surface are closer to the touch function side than the other side, and the second surface and the fourth surface are closer to the other side than the touch function side such that the plurality of electric field lines distributed above a plane formed by an extension of the first surface and the third surface, and closer to the touch function side than the other side are denser than the plurality of electric field lines distributed below the plane, and closer to the other side than the touch function side.

2. The touch panel according to Embodiment 1, wherein the transmitter further includes a first side and a second side, the receiver further includes a third side and a fourth side, a first longitudinal section formed by the first surface, the second surface, the first side and the second side, and a second longitudinal section formed by the third surface, the fourth surface, the third side and the fourth side are both a trapezoid, and when the second width and the fourth width both approach a minimum value, the first and the second longitudinal sections both approach a triangle.

3. The touch panel according to Embodiment 1 or 2, wherein the transmitter further includes a first side and a second side, the receiver further includes a third side and a fourth side, each of the first to the fourth sides is one of a plane and a curved surface, when each of the first to the fourth sides is an arc-shaped surface protruding outward and the second width and the fourth width both approach a minimum value, a first longitudinal section formed by the first surface, the second surface, the first side and the second side, and a second longitudinal section formed by the third surface, the fourth surface, the third side and the fourth side are both a semicircle.

4. The touch panel according to any one of the above-mentioned Embodiments, wherein the transmitter and the receiver are both formed by an isotropic etching.

5. A touch panel, comprising:

a screen having a touch function side and the other side opposite to the touch function side; and

a sensor including a transmitter having a first surface and a second surface, and generating a plurality of electric field lines,

wherein the first and the second surfaces respectively have a first and a second widths, the second width is smaller than the first width, the first surface is closer to the touch function side than the other side, and the second surface is closer to the other side than the touch function side such that the plurality of electric field lines distributed above a plane formed by an extension of the first surface, and closer to the touch function side than the other side are denser than the plurality of electric field lines distributed below the plane, and closer to the other side than the touch function side.

6. The touch panel according to Embodiment 5, wherein the sensor further includes a receiver having a third surface and a fourth surface, the third surface and the fourth surface respectively have a third width and a fourth width, and the fourth width is smaller than the third width such that the plurality of electric field lines received by the receiver, distributed above the plane formed by an extension of the first surface and the third surface, and closer to the touch function side than the other side, are denser than those distributed below the plane, and closer to the other side than the touch function side.

7. A touch panel, comprising:
a screen;

a substrate; and

a transmitting/receiving unit configured between the screen and the substrate, and having a first surface near the screen and a second surface near the substrate, wherein the first surface has a size larger than that of the second surface.

8. A touch panel, comprising:

a screen;

a substrate; and

a transmitting/receiving unit configured between the screen and the substrate, having a first surface near the screen and a second surface near the substrate, and configured to cause electric field lines to be generated by the unit, distributed above the plane formed by an extension of the first surface, and closer to the touch function side than the other side, to be denser than those distributed below the plane, and closer to the other side than the touch function side.

9. A controlling method for a touch panel, wherein the touch panel has a touch function side and the other side opposite to the touch function side, the controlling method comprising:

providing a sensor, wherein the sensor includes a transmitter having a first surface and a second surface, and a receiver having a third surface and a fourth surface, the first surface and the third surface are closer to the touch function side than the other side, and the second surface and the fourth surface are closer to the other side than the touch function side;

generating a plurality of electric field lines from the transmitter to the receiver when the sensor is operated; and

causing the second width to be smaller than the first width and the fourth width to be smaller than the third width such that the plurality of electric field lines distributed above a plane formed by an extension of the first surface and the third surface, and closer to the touch function side than the other side are denser than the plurality of electric field lines distributed below the plane, and closer to the other side than the touch function side.

10. The controlling method according to Embodiment 9, further comprising:

causing a touch when a user uses one of a finger and an object to approach the touch function side on a condition that a distance between the touch panel and the one of the finger and the object is less than a maximum detecting height; and

confirming a position of the touch via the plurality of electric field lines changed by the one of the finger and the object to detect an energy change between a time before the touch and a time after the touch, wherein through the plurality of electric field lines densely distributed above the plane and closer to the touch function side than the other side, the touch is relatively sensitively detected and the maximum detecting height is relatively increased.

11. A controlling method for a touch panel, wherein the touch panel includes a screen having a touch function side and the other side opposite to the touch function side, the controlling method comprising:

providing a sensor having a transmitter, wherein the transmitter has a first surface and a second surface, the first surface is closer to the touch function side, and the second surface is closer to the other side;

causing the transmitter to generate a plurality of electric field lines when the sensor is operated; and

causing the second width to be smaller than the first width such that the plurality of electric field lines distributed above the plane formed by an extension of the first surface, and closer to the touch function side than the other side are denser than those distributed below the plane, and closer to the other side than the touch function side.

12. The controlling method according to Embodiment 11, wherein the sensor further includes a receiver having a third surface and a fourth surface, and the third surface and the fourth surface respectively have a third width and a fourth width, the controlling method further comprising:

causing the fourth width to be smaller than the third width such that the plurality of electric field lines received by the receiver, distributed above the plane, and closer to the touch function side than the other side are denser than those distributed below the plane, and closer to the other side than the touch function side;

causing a touch when a user uses one of a finger and an object to approach the touch function side on a condition that a distance between the touch panel and the one of the finger and the object is less than a maximum detecting height; and

confirming a position of the touch via the plurality of electric field lines changed by the one of the finger and the object to detect an energy change between a time before the touch and a time after the touch, wherein through the plurality of electric field lines densely distributed above the plane, and closer to the touch function side than the other side, the touch is relatively sensitively detected and the maximum detecting height is relatively increased.

According to the descriptions above, the present invention discloses a touch panel having unevenly distributed electric field lines, wherein the touch panel comprises a sensor, the sensor includes a transmitter parallel to a touch function side, and having a wider first surface and a narrower second surface, and a receiver parallel to the touch function side, and having a wider third surface and a narrower fourth surface such that a plurality of electric field lines distributed above a plane formed by an extension of the first surface and the third surface, and closer to the touch function side than the other side are denser than the plurality of electric field lines distributed below the plane, and closer to the other side than the touch function side to increase the sensitivity to the touch and to increase a detecting height of the touch.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A touch panel, comprising a sensor including:
a transmitter having a first surface and a second surface; and
a receiver having a third surface and a fourth surface,
wherein when the sensor is operated, a plurality of electric field lines are generated from the transmitter to the receiver, the touch panel has a touch function side and the other side opposite to the touch function side, the first to the fourth surfaces respectively have a first to a fourth widths, the second width is smaller than the first width, the fourth width is smaller than the third width, the first surface and the third surface are closer to the touch function side than the other side, and the second surface and the fourth surface are closer to the other side than the touch function side such that the plurality of electric field lines distributed above a plane formed by an extension of the first surface and the third surface, and closer to the touch function side than the other side are denser than the plurality of electric field lines distributed below the plane, and closer to the other side than the touch function side.

2. The touch panel according to claim 1, wherein the transmitter further includes a first side and a second side, the receiver further includes a third side and a fourth side, a first longitudinal section formed by the first surface, the second surface, the first side and the second side, and a second longitudinal section formed by the third surface, the fourth surface, the third side and the fourth side are both a trapezoid, and when the second width and the fourth width both approach a minimum value, the first and the second longitudinal sections both approach a triangle.

3. The touch panel according to claim 1, wherein the transmitter further includes a first side and a second side, the receiver further includes a third side and a fourth side, each of the first to the fourth sides is one of a plane and a curved surface, when each of the first to the fourth sides is an arc-shaped surface protruding outward and the second width and the fourth width both approach a minimum value, a first longitudinal section formed by the first surface, the second surface, the first side and the second side, and a second longitudinal section formed by the third surface, the fourth surface, the third side and the fourth side are both a semicircle.

4. The touch panel according to claim 1, wherein the transmitter and the receiver are both formed by an isotropic etching.

5. A touch panel, comprising:
a screen having a touch function side and the other side opposite to the touch function side; and
a sensor including a transmitter having a first surface and a second surface, and generating a plurality of electric field lines,
wherein the first and the second surfaces respectively have a first and a second widths, the second width is smaller than the first width, the first surface is closer to the touch function side than the other side, and the second surface is closer to the other side than the touch function side such that the plurality of electric field lines distributed above a plane formed by an extension of the first surface, and closer to the touch function side than the other side are denser than the plurality of electric field lines distributed below the plane, and closer to the other side than the touch function side.

6. The touch panel according to claim 5, wherein the sensor further includes a receiver having a third surface and a fourth surface, the third surface and the fourth surface respectively have a third width and a fourth width, and the fourth width is smaller than the third width such that the plurality of electric field lines received by the receiver, distributed above the plane formed by an extension of the first surface and the third surface, and closer to the touch function side than the other side, are denser than those distributed below the plane, and closer to the other side than the touch function side.

7. A touch panel, comprising:
a screen;
a substrate; and
a transmitting/receiving unit configured between the screen and the substrate, and having a first surface near the screen and a second surface near the substrate, wherein the first surface has a size larger than that of the second surface.

8. A touch panel, comprising:
a screen;
a substrate; and
a transmitting/receiving unit configured between the screen and the substrate, having a first surface near the screen and a second surface near the substrate, and configured to cause electric field lines to be generated by the unit, distributed above the plane formed by an extension of the first surface, and closer to the touch function side than the other side, to be denser than those distributed below the plane, and closer to the other side than the touch function side.

9. A controlling method for a touch panel, wherein the touch panel has a touch function side and the other side opposite to the touch function side, the controlling method comprising:
providing a sensor, wherein the sensor includes a transmitter having a first surface and a second surface, and a receiver having a third surface and a fourth surface, the first surface and the third surface are closer to the touch function side than the other side, and the second surface and the fourth surface are closer to the other side than the touch function side;
generating a plurality of electric field lines from the transmitter to the receiver when the sensor is operated; and
causing the second width to be smaller than the first width and the fourth width to be smaller than the third width such that the plurality of electric field lines distributed above a plane formed by an extension of the first surface and the third surface, and closer to the touch function side than the other side are denser than the plurality of electric field lines distributed below the plane, and closer to the other side than the touch function side.

10. The controlling method according to claim 9, further comprising:
causing a touch when a user uses one of a finger and an object to approach the touch function side on a condition that a distance between the touch panel and the one of the finger and the object is less than a maximum detecting height; and
confirming a position of the touch via the plurality of electric field lines changed by the one of the finger and the object to detect an energy change between a time before the touch and a time after the touch, wherein through the plurality of electric field lines densely distributed above the plane and closer to the touch function side than the other side, the touch is relatively sensitively detected and the maximum detecting height is relatively increased.

11. A controlling method for a touch panel, wherein the touch panel includes a screen having a touch function side and the other side opposite to the touch function side, the controlling method comprising:
providing a sensor having a transmitter, wherein the transmitter has a first surface and a second surface, the first surface is closer to the touch function side, and the second surface is closer to the other side;
causing the transmitter to generate a plurality of electric field lines when the sensor is operated; and
causing the second width to be smaller than the first width such that the plurality of electric field lines distributed above the plane formed by an extension of the first surface, and closer to the touch function side than the other side are denser than those distributed below the plane, and closer to the other side than the touch function side.

12. The controlling method according to claim 11, wherein the sensor further includes a receiver having a third surface and a fourth surface, and the third surface and the fourth surface respectively have a third width and a fourth width, the controlling method further comprising:
causing the fourth width to be smaller than the third width such that the plurality of electric field lines received by the receiver, distributed above the plane, and closer to the touch function side than the other side are denser than those distributed below the plane, and closer to the other side than the touch function side;
causing a touch when a user uses one of a finger and an object to approach the touch function side on a condition that a distance between the touch panel and the one of the finger and the object is less than a maximum detecting height; and
confirming a position of the touch via the plurality of electric field lines changed by the one of the finger and the object to detect an energy change between a time before the touch and a time after the touch, wherein through the plurality of electric field lines densely distributed above the plane, and closer to the touch function side than the other side, the touch is relatively sensitively detected and the maximum detecting height is relatively increased.
